(19) United States
(12) Patent Application Publication
(10) Pub. No.: US 2012/0155691 A1
(43) Pub. Date: Jun. 21, 2012

(54) WIRED EARPHONE

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/091,142

(22) Filed: Apr. 21, 2011

(30) Foreign Application Priority Data
Dec. 20, 2010 (CN) 201010596746.5

(51) Int. Cl. H04R 1/10

(52) U.S. Cl. 381/380

(57) ABSTRACT

An exemplary earphone includes a shell, a speaker received in the shell and a wire electrically connecting with the speaker. The shell defines a sound cavity and a wire passage therein. The sound cavity and the wire passage communicate with each other. The speaker is received in the sound cavity. The wire is inserted into the sound cavity through the wire passage. The earphone further includes a mounting sleeve. The mounting sleeve defines a mounting hole therein. The mounting sleeve is mounted in the wire passage of the shell. The wire is fixed in the mounting hole of the mounting sleeve.

### CROSS-REFERENCE TO RELATED APPLICATION

This application is related to a U.S. patent application entitled “WIRED EARPHONE”, filed on the same date as this application and having the same assignee as this application. The disclosure of the above-identified application is incorporated herein by reference.

### BACKGROUND

1. Technical Field

The present disclosure relates to earphones, and particularly to a wired earphone.

2. Description of Related Art

A typical earphone includes a shell, a speaker mounted in the shell, and a wire electrically connected with the speaker. The shell defines a sound cavity therein and a through hole communicating with the sound cavity. The speaker is located in the sound cavity. The wire is inserted into the sound cavity through the through hole. A diameter of the through hole is usually slightly larger than that of the wire, for facilitating the wire to extend through the through hole. The wire is thus loosely received in the through hole of the shell. When the earphone is in use and the exposed portion of the wire is accidentally brushed or moved by the user, the wire is liable to move in the through hole and impact an inner wall of the shell around of the through hole. This may generate unwanted noise.

Furthermore, during use of the earphone, some external contaminants, such as dust and sweat, may infiltrate into the sound cavity of the shell through a clearance defined between the wire and the edge of the through hole. This can adversely affect the sound quality of the earphone, and may even cause damage to the speaker.

Accordingly, what is needed is an earphone which can overcome the limitations described.

### BRIEF DESCRIPTION OF THE DRAWINGS

FIG. 1 is an isometric, assembled view of an earphone in accordance with a first embodiment of the present disclosure.

FIG. 2 is an isometric, exploded view of the earphone of FIG. 1, showing another aspect thereof, but omitting a wire thereof.

FIG. 3 is a bottom view of a back cover of a shell of the earphone of FIG. 2.

FIG. 4 is an enlarged, tail end view of a mounting sleeve of the earphone of FIG. 2.

FIG. 5 is a cross-sectional view of the earphone of FIG. 1, taken along line V-V thereof.

FIG. 6 is a cross-sectional view of an earphone in accordance with a second embodiment of the present disclosure.

### DETAILED DESCRIPTION

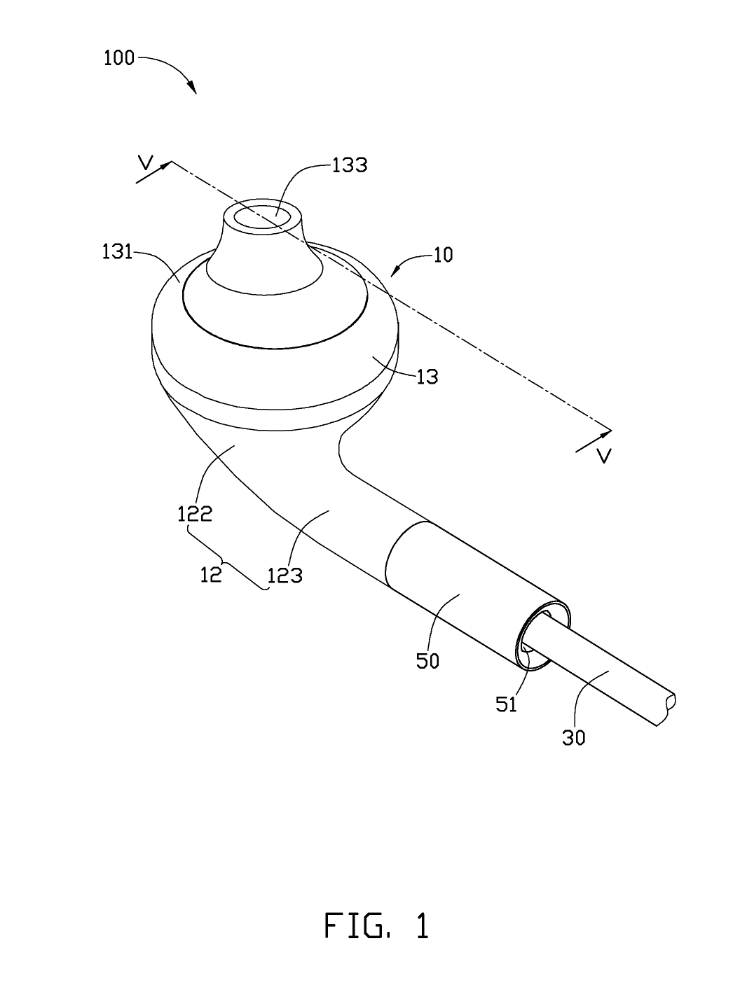

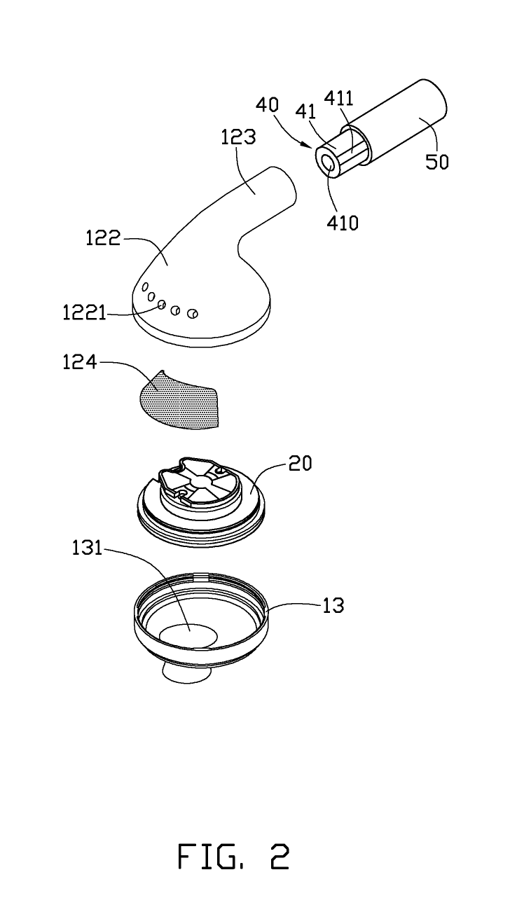

Referring to FIGS. 1-2, an earphone 100 according to a first embodiment of the present disclosure is shown. The earphone 100 includes a shell 10, a speaker 20 mounted in the shell 10, a wire 30 electrically connected with the speaker 20, a mounting sleeve 40 fixing the wire 30, and a buffer sleeve 50 placed around the mounting sleeve 40. In this embodiment, the wire 30 is an electrical cable covered with an insulating sheath.

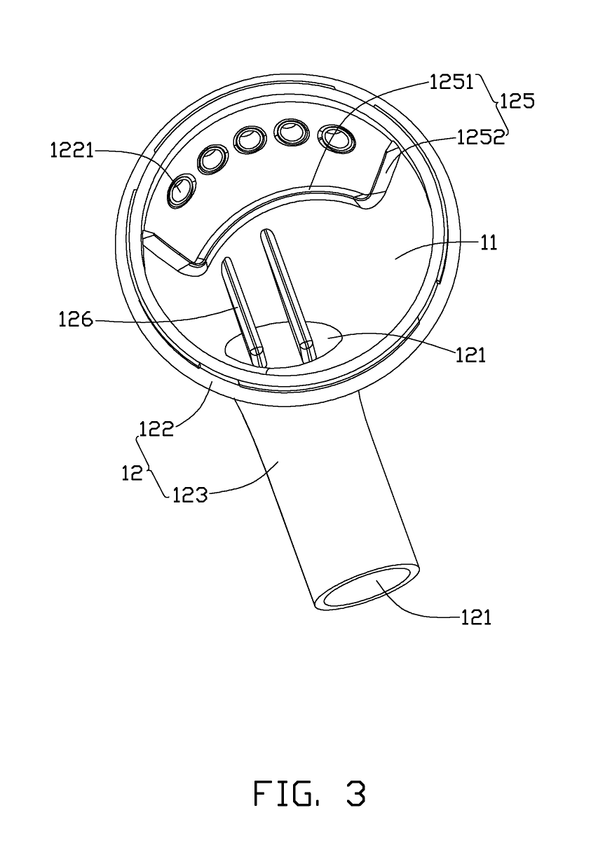

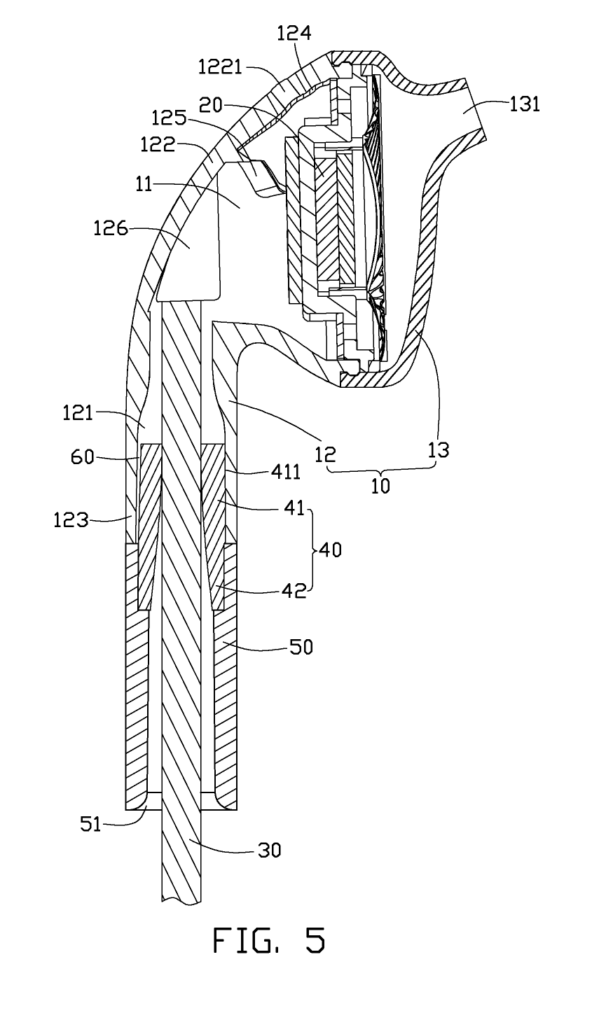

Referring also to FIGS. 3 and 5, the shell 10 is hollow and defines a sound cavity 11 therein. The speaker 20 is received in the sound cavity 11. The shell 10 includes a back cover 12, and a front cover 13 engaging with the back cover 12. The back cover 12 and the front cover 13 cooperatively define the sound cavity 11.

The back cover 12 defines a wire passage 121 therein. The wire passage 121 communicates with the sound cavity 11. The back cover 12 includes an expanding main body 122, and a tubular handle portion 123 extending from the main body 122. The wire passage 121 extends through the handle portion 123 longitudinally.

The main body 122 defines a plurality of sound pores 1221 therein, the sound pores 1221 communicating with the sound cavity 11. The sound pores 1221 are identical to each other, and are arranged in an imaginary arc line adjacent to an edge of the main body 122. A nonwoven piece 124 is attached on an inner wall of the main body 122 at a position defining the sound pores 1221. The nonwoven piece 124 is porous and covers the sound pores 1221, and is for adjusting a sound quality of the earphone 100 and protecting external contaminants from entering the sound cavity 11 of the earphone 100. A restricting flange 125 protrudes from the inner wall of the main body 122 toward the sound cavity 11. The restricting flange 125 surrounds the sound pores 1221, restricting a position of the nonwoven piece 124. The restricting flange 125 includes an arc portion 1251, and two straight portions 1252 at two opposite ends of the arc portion 1251. The arc portion 1251 is located between the sound pores 1221 and the wire passage 121. The two straight portions 1252 are located at two opposite sides of the sound pores 1221. Two positioning plates 126 protrude from the inner wall of the main body 122 adjacent to the wire passage 121. The two positioning plates 126 are parallel to each other. The wire 30 is positioned between the two positioning plates 126.

The front cover 13 is disc-shaped, and defines a sound leakage hole 131 facing the speaker 20 for releasing a sound of the speaker 20 to an outside of the earphone 100. The sound pores 1221 of the back cover 12 and the sound leakage hole 131 of the front cover 13 are respectively located at two opposite sides of the speaker 20, for adjusting an air pressure difference between the two opposite sides of the speaker 20.

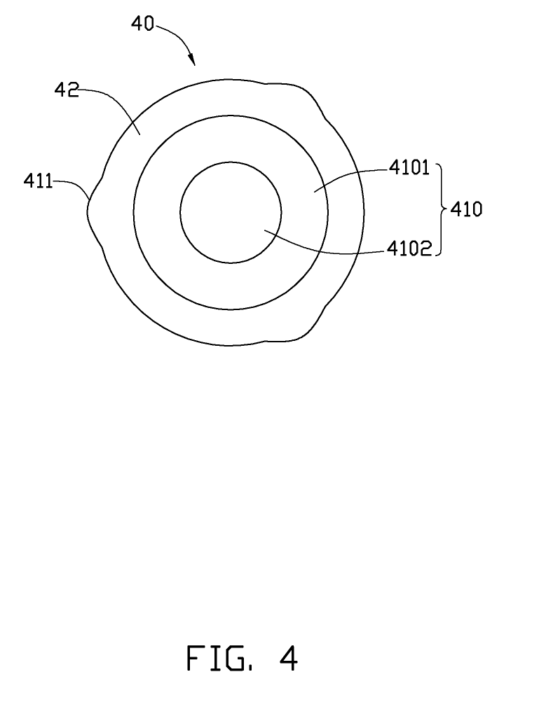

Referring to FIGS. 4 and 5, the mounting sleeve 40 is made of hard plastic, metal, or other suitable material. The mounting sleeve 40 is tubular, and includes a head portion 41 and a tail portion 42. The head portion 41 and tail portion 42 are aligned along an axis of the mounting sleeve 40, and together can be considered to comprise the entirety of the mounting sleeve 40. The head portion 41 is fixed in the wire passage 121. The tail portion 42 is located outside the wire passage 121, and the buffer sleeve 50 is attached around the tail portion 42 of the mounting sleeve 40. An outer diameter of the mounting sleeve 40 is a little less than a diameter of the wire passage 121. Three ribs 411 are formed on an outer wall of the head portion 41 of the mounting sleeve 40. The ribs 411 are parallel to and evenly spaced from each other. Each of the ribs 411 is strip-shaped, and parallel to the axis of the mounting sleeve 40. That is, the ribs 411 are equally angularly spaced from each other around a circumference of the head portion 41. The ribs 411 abut against an inner wall of the handle portion 123 around the wire passage 121, spacing the outer wall of the head portion 41a short distance from the inner wall of the handle portion 123 around the wire passage 121. A clearance 60 is defined between the outer wall of the head portion 41 of the mounting sleeve 40 and the inner wall of the handle portion 123 around the wire passage 121. The clearance 60 surrounds the mounting sleeve 40 and is divided into three parts by the three ribs 411, thereby weakening noises transmitting from the mounting sleeve 40 to the shell 10.

The mounting sleeve 40 defines a mounting hole 410 therein along an axis thereof. The mounting hole 410 of the mounting sleeve 40 communicates with the wire passage 121 of the shell 10 for extending of the wire 30 therethrough. The mounting hole 410 is tapered along a direction from the tail portion 42 to the head portion 41. An amplifying opening 4101 and a contracting opening 4102 are respectively defined at two opposite ends of the mounting hole 410. The amplifying opening 4101 runs through the tail portion 42 of the mounting sleeve 40, and is open in a direction away from the sound cavity 11. The contracting opening 4102 runs through the head portion 41 of the mounting sleeve 40, and is open in a direction toward the sound cavity 11. A diameter of the contracting opening 4102 is less than that of the amplifying opening 4101. Thus the mounting hole 410 is tapered from the amplifying opening 4101 to the contracting opening 4102. A diameter of the wire 30 is approximately equal to that of the contracting opening 4102.

The buffer sleeve 50 is made of resilient and sealable soft material such as rubber, silica gel, or other suitable soft material. The buffer sleeve 50 is tubular and defines a through hole 51 therein along an axis thereof. An outer diameter of the buffer sleeve 50 is substantially equal to that of the handle portion 123 of the back cover 12 of the shell 10. An inner diameter of the buffer sleeve 50, i.e., a diameter of the through hole 51, is less than the outer diameter of the mounting sleeve 40 but exceeds the diameter of the wire 30. A front portion of the buffer sleeve 50 is attached around the tail portion 42 of the mounting sleeve 40. That is, a portion of the through hole 51 in the front portion of the buffer sleeve 50 has an enlarged diameter. A back portion of the buffer sleeve 50 extends beyond the mounting sleeve 40. That is, a portion of the through hole 51 in the back portion of the buffer sleeve 50 has a reduced diameter. Thus the buffer sleeve 50 has an annular inner step where the front portion of the buffer sleeve 50 adjoins the back portion of the buffer sleeve 50. The front portion of the through hole 51 of the buffer sleeve 50 communicates with the mounting hole 410 of the mounting sleeve 40 for extending of the wire 30 therethrough. Therefore bending of a portion of the wire 30 exposed outside the mounting sleeve 40 can be gently restricted by the buffer sleeve 50. This decreases the risk of damage to or breakage of the wire 30 due to such bending.

In assembly of the earphone 100, the wire 30 is inserted into the mounting hole 410 of the mounting sleeve 40 from the amplifying opening 4101. Because the mounting hole 410 of the mounting sleeve 40 is tapered from the amplifying opening 4101 to the contracting opening 4102, and because the diameter of the wire 30 is approximately equal to that of the contracting opening 4102, the wire 30 can run through the mounting hole 410 of the mounting sleeve 40 conveniently, and can be firmly fixed in the contracting opening 4102 of the mounting hole 410. During use of the earphone 100, an inner wall of the mounting sleeve 40 at the contracting opening 4102 prevents the wire 30 from moving in the mounting sleeve 40. Therefore noise generated by impacting and scraping as between the wire 30 and the inner wall of the mounting sleeve 40 is avoided. At the same time, the wire 30 seals the contracting opening 4102, preventing external contaminants from entering the sound cavity 11 of the earphone 100 via the mounting hole 410. An inner structure of the earphone 100 is thus protected.

In addition, the buffer sleeve 50 is attached around the tail portion 42 of the mounting sleeve 40, and a front end of the buffer sleeve 50 abuts against a free end of the handle portion 123 of the shell 10. Thereby, the clearance 60 between the outer wall of the mounting sleeve 40 and the inner wall of the handle portion 123 around the wire passage 121 is sealed by the buffer sleeve 50, further preventing external contaminant from entering into the sound cavity 11 of the earphone 100 via the clearance 60.

Furthermore, the mounting sleeve 40 and the buffer sleeve 50 cooperatively seal the wire passage 121 of the shell 10, and the shell 10 of the earphone 100 defines a plurality of sound pores 1221 therein, thus causing the sound cavity 11 of the shell 10 to be a resonance chamber. Therefore, the quality of lower frequency sounds output by the earphone 10 can be improved.

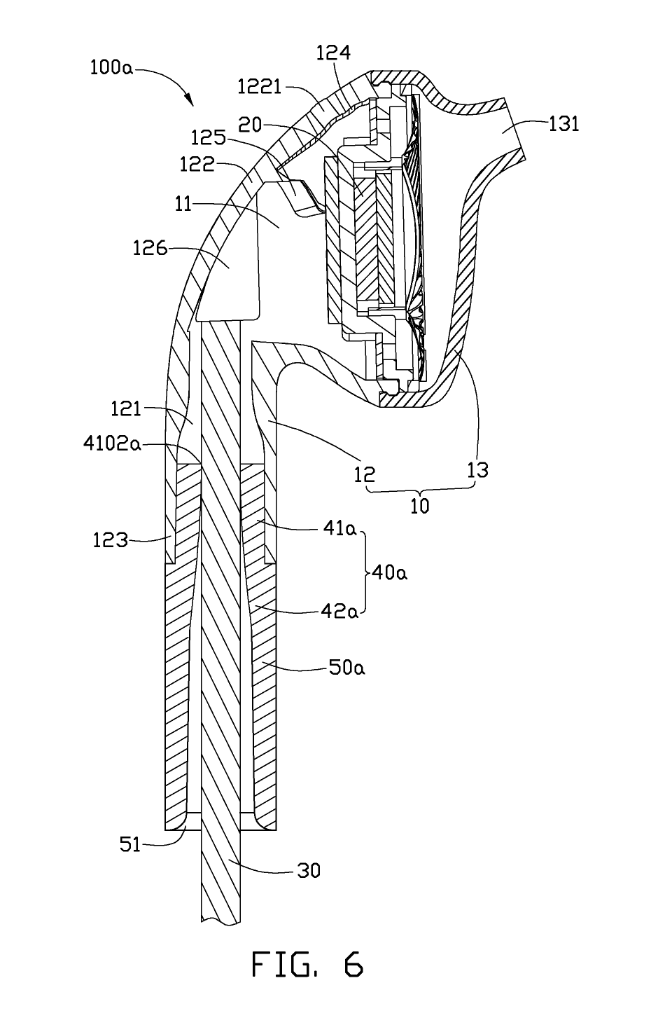

Referring to FIG. 6, an earphone 100a according to a second embodiment of the present disclosure is shown. The earphone 100a is similar to that of the previous embodiment. Differently, in the earphone 100a, a mounting sleeve 40a and a buffer sleeve 50a are integrally formed as one monolithic piece of the same material. Such material can be a resilient, sealable soft material, such as rubber, silica gel, or other suitable soft material. An outer wall of a head portion 41a of the mounting sleeve 40a smoothly and intimately contacts an inner wall of the handle portion 123 of the shell 10 around the wire passage 121 without interruption. That is, the head portion 41a of the mounting sleeve 40a does not include any ribs, and there is no clearance defined between the outer wall of the head portion 41a and the inner wall of the handle portion 123. A diameter of a contracting opening 4102a of the mounting sleeve 40a is a little less than the diameter of the wire 30. For example, when the diameter of the wire 30 is 1.2 millimeters, the diameter of the contracting opening 4102a can be 1.15 millimeters. When the wire 30 extends through the contracting opening 4102a, an inner wall of the mounting sleeve 40a at the contracting opening 4102a resiliently swells slightly. Thus the wire 30 is fixed in the contracting opening 4102a due to resilient contracting force applied by the inner wall of the mounting sleeve 40a at the contracting opening 4102a. Furthermore, the mounting sleeve 40a, the buffer sleeve 50a and the wire 30 cooperatively seal the wire passage 121 of the shell 10, preventing external contaminants from entering the sound cavity 11 of the earphone 100a.

It is to be understood, however, that even though numerous characteristics and advantages of the exemplary embodiments have been set forth in the foregoing description, together with details of the structures and functions of the embodiments, the disclosure is illustrative only, and that changes may be made in detail, especially in matters of shape, size, and arrangement of parts within the principles of the embodiments to the full extent indicated by the broad general meaning of the terms in which the appended claims are expressed.

What is claimed is:

1. An earphone comprising:
a shell defining a sound cavity and a wire passage therein, the sound cavity and the wire passage communicating with each other;
a speaker mounted in the sound cavity;
a wire extending through the wire passage to the sound cavity and electrically connected with the speaker; and
a mounting sleeve mounted in the wire passage, the mounting sleeve defining a mounting hole therein, the wire fixed in the mounting hole.

2. The earphone of claim 1, wherein the mounting hole comprises an amplifying opening and a contracting opening at two opposite ends thereof, the mounting hole is tapered from the amplifying opening to the contracting opening, the contracting opening is open in a direction toward the wire passage, a diameter of the amplifying opening exceeds that of the contracting opening, and the wire is fixed in the contracting opening and seals the contracting opening.

3. The earphone of claim 2, wherein a plurality of ribs are formed on an outer wall of the mounting sleeve, the ribs are spaced from each other around the outer wall of the mounting sleeve and extend parallel to an axis of the mounting sleeve, each of the ribs abuts against an inner wall of the shell around the wire passage, a clearance is defined between the outer wall of the mounting sleeve and the inner wall of the shell around the wire passage, and the clearance is divided into a plurality of parts by the ribs.

4. The earphone of claim 3, wherein the plurality of ribs comprises three ribs, and the three ribs are equally angularly spaced from each other.

5. The earphone of claim 3, further comprising a buffer sleeve, wherein the mounting sleeve comprises a head portion and a tail portion, the head portion is mounted in the wire passage, the ribs are formed on an outer wall of the head portion, the tail portion extends beyond the wire passage, and the buffer sleeve is attached around the tail portion of the mounting sleeve and seals the clearance.

6. The earphone of claim 5, wherein the buffer sleeve extends beyond the tail portion of the mounting sleeve, and is made of resilient and sealable soft material.

7. The earphone of claim 2, further comprising a buffer sleeve, wherein the buffer sleeve and the mounting sleeve are integrally formed as one monolithic piece of the same resilient and sealable material, an outer wall of the mounting sleeve contacts an inner wall of the shell around the wire passage, the diameter of the contracting opening is less than a diameter of the wire, the buffer sleeve defines a through hole therein communicating with the wire passage, the wire extends through the through hole and seals the contracting opening, and the mounting sleeve and the wire cooperatively seal the wire passage.

8. The earphone of claim 2, wherein the shell further defines a plurality of sound pores communicating with the sound cavity.

9. The earphone of claim 8, further comprising a porous nonwoven piece attached on an inner wall of the shell at a position defining the sound pores, and the nonwoven piece covers the sound pores.

10. The earphone of claim 9, wherein a restricting flange is formed on the inner wall of the shell for restricting a position of the nonwoven piece, the restricting flange comprises an arc portion and two straight portions at two opposite ends of the arc portion, the arc portion is positioned between the plurality of sound pores and the wire passage, and the two straight portions are respectively located at two opposite sides of the plurality of sound pores.

11. The earphone of claim 8, wherein the shell comprises a front cover and a back cover engaging with the front cover, the front cover and the back cover cooperatively define the sound cavity, the plurality of sound pores are defined in the back cover, the front cover defines a sound leakage hole therein, and the plurality of sound pores and the sound leakage hole are respectively located at two opposite sides of the speaker.

12. The earphone of claim 11, wherein the back cover comprises a main body and a handle portion extending from the main body, the wire passage extends through the handle portion, two positioning plates are formed at an inner wall of the shell adjacent to the wire passage, the two positioning plates are parallel to each other, and the wire is positioned between the two positioning plates.

13. An earphone comprising:
a shell defining a sound cavity and a wire passage therein, the sound cavity and the wire passage communicating with each other, the shell further defining a plurality of sound pores therein communicating with the sound cavity;
a speaker mounted in the sound cavity;
a wire extending through the wire passage to the sound cavity and electrically connected with the speaker;
a mounting sleeve mounted in the wire passage, the mounting sleeve defining a mounting hole therein, and the wire fixed in the mounting hole; and
a buffer sleeve coupled to the mounting sleeve, wherein the mounting sleeve, the buffer sleeve and the wire cooperatively seal the wire passage.

14. The earphone of claim 13, wherein the mounting hole comprises an amplifying opening and a contracting opening at two opposite end thereof, the mounting hole is tapered from the amplifying opening to the contracting opening, the contracting opening is open in a direction toward the wire passage, a diameter of the amplifying opening exceeds that of the contracting opening, and the wire is fixed in the contracting opening and seals the contracting opening.

15. The earphone of claim 13, wherein a plurality of ribs are formed on an outer wall of the mounting sleeve, the ribs are spaced from each other around the outer wall of the mounting sleeve and extend parallel to an axis of the mounting sleeve, each of the ribs abuts against an inner surface of the wire passage, a clearance is defined between the outer wall of the mounting sleeve and the edge of the wire passage, and the clearance is divided into a plurality of parts by the ribs.

16. The earphone of claim 15, wherein the mounting sleeve comprises a head portion and a tail portion, the head portion is mounted in the wire passage, the ribs are formed on an out wall of the head portion, the tail portion extends beyond the wire passage, and the buffer sleeve is attached around the tail portion of the mounting sleeve, and the buffer sleeve seals the clearance.

17. The earphone of claim 14, wherein the buffer sleeve and the mounting sleeve are integrally formed as one monolithic piece of the same resilient and sealable soft material, a outer wall of the mounting sleeve contacts the edge of the wire passage, the diameter of the contracting opening is less than a diameter of the wire, the buffer sleeve defines a through hole therein communicating with the wire passage, and the wire seals the contracting opening.

18. The earphone of claim 14, further comprising a porous nonwoven piece attached on an inner wall of the shell at a position defining the sound pores, and the nonwoven piece covers the sound pores.

19. The earphone of claim 18, wherein the shell comprises a front cover and a back cover engaging with the front cover, the front cover and the back cover cooperatively define the sound cavity, the plurality of sound pores are defined in the back cover, the front cover defines a sound leakage hole therein, the sound pores and the sound leakage hole are respectively located at two opposite sides of the speaker.

20. The earphone of claim 19, wherein the back cover comprises a main body and a handle portion extending from the main body, the wire passage is defined in the handle portion, two positioning plates are formed at the inner wall of the shell facing the wire passage, the two positioning plates are parallel to each other, and the wire is positioned between the two positioning plates.
